(19) United States
(12) Patent Application Publication
(10) Pub. No.: US 2007/0138690 A1
(43) Pub. Date: Jun. 21, 2007

(54) Process for producing synthetic resin film having molecular orientation controlled in md direction

(75) Inventors: Takaaki Matsuwaki, Shizuoka (JP); Kazuhiro Ono, Shiga (JP); Kan Fujihara, Shiga (JP); Toshihisa Itoh, Kyoto (JP); Kiyokazu Akahori, Shiga (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Kaneka Corporation, Osaka (JP)

(21) Appl. No.: 10/590,494

(22) PCT Filed: Feb. 8, 2005
(86) PCT No.: PCT/JP05/02200

§ 371 Date: Aug. 24, 2006

(30) Foreign Application Priority Data
Feb. 27, 2004 (JP) 2004-055005

(51) Int. Cl. B29C 39/14

(52) U.S. Cl. 264/216

(57) ABSTRACT

It is an object of the present invention to provide a stable process for continuously producing a synthetic resin film oriented in the machine direction across the full width. The present invention provides a process for producing a synthetic resin film including step (A) of casting and applying a composition containing a polymer and an organic solvent onto a support to form a gel film; step (B) of stripping the gel film and heating the gel film with both ends being fixed; and step (C) of heating the film with both ends being released after step (B), wherein the thickness b of the film produced in step (B) and the thickness c of the film produced in step (C) satisfy the relationship: b>c.

### TECHNICAL FIELD

The present invention relates to a continuous forming process for producing a synthetic resin film having molecular orientation controlled in a machine direction (MD).

### BACKGROUND ART

Demands for higher density mounting in the electronic technical field and the like have been increased. Thus, demands for higher density mounting in the technical field of flexible printed circuit boards (hereinafter, referred to as “FPC”) have also been increased. Steps for producing FPCs are broadly divided into a step of laminating a metal on a base film; and a step of forming lines on the surface of the metal. Changes in dimensions occur in a step of patterning the metal by etching and a step of heating the formed FPC. FPCs having reduced changes in dimensions in such steps have been needed. To meet the need, the present inventors consider that synthetic resin films, each having molecular orientation controlled in a machine direction (MD), are useful. In other words, the inventors consider that the films each having molecular orientation controlled in a machine direction (MD) and thus having different physical properties in the machine direction and the direction perpendicular to the machine direction (width direction, transverse direction (TD)), are useful. More specifically, in laminating the metal, it is useful for the reduction of the changes in dimensions (in the patterning step and the heating step of the formed FPC) to use a base film comprising a synthetic resin film having molecular orientation controlled in the machine direction in a step of laminating a metal foil while heating the base film.

The molecular orientation controlled in the machine direction results in high modulus of elasticity in the flow direction (machine direction) of a film and thus reduces the effect of tension. Therefore, it is possible to reduce the changes in dimensions in the steps described above.

Furthermore, the film having molecular orientation controlled in the machine direction has high modulus of elasticity in the machine direction. When the film has a small thickness (for example, 12.5 μm or less), the film has improved handleability in roll-to-roll processing. As a result, the yield with respect to product appearance is improved.

Thus, a film having molecular orientation controlled in the machine direction across the full width will be useful for use in the FPC, a chip on flexible printed circuit board (COF) process, and a tape automated bonding (TAB) process in the electronic field. At the present time, however, such films have not been produced.

For example, Patent Document 1 discloses a process for drawing a film at a draw ratio of 1.0 to 1.5 in the machine direction and 0.5 to 0.99 in the transverse direction in forming the film. However, this production process includes fixing the ends of a self-supporting polyamic acid film; drawing the film in the machine direction and transverse direction while heat-treating the film; and then gradually heating the self-supporting polyamic acid film to cause imidization. This process differs from a process of the present invention. Furthermore, in drawing the self-supporting polyamic acid film, the drawn film may have nonuniform properties. A specific example of the disclosed process disclosed includes a batch production process. An industrial process for continuously producing a film having controlled molecular orientation across the full width is not disclosed.

Patent Document 2 discloses a process for drawing a baked polyimide film in the machine direction while annealing. As a result of satisfactory imidization, there is no residual solvent in the baked polyimide film. In drawing such a baked polyimide film, it is often difficult to stably keep a balance of properties in the machine direction and transverse direction. Even when the baked film can be drawn, the resulting drawn film frequently has wrinkles like a galvanized corrugated sheet. This results in a practical problem.

Patent Document 3 discloses a process for producing a polyimide film oriented in the machine direction by zone drawing at 250° C. or more under a tension of 10 kg/mm² or more. The resulting drawn film has wrinkles like a galvanized corrugated sheet in the transverse direction due to excessively high tension. Therefore, such a film cannot be practically used as a base film.

[Patent Document 1] Japanese Unexamined Patent Application Publication No. 11-156936, 0021

[Patent Document 2] Japanese Unexamined Patent Application Publication No. 8-174659, 0017

[Patent Document 3] Japanese Unexamined Patent Application Publication No. 63-197628, page 2, upper right column, line 15.

### DISCLOSURE OF INVENTION

A stable process for continuously producing a synthetic resin film oriented in the machine direction across the full width has not been found in the related art.

1) The present invention provides a process for producing a synthetic resin film including at least the following steps (A) to (C):

(A) a step of casting and applying a composition containing a polymer and an organic solvent onto a support to form a gel film;

(B) a step of stripping the gel film and heating the gel film with both ends being fixed; and

(C) a step of heating the film with both ends being released after step (B), wherein the thickness b of the film produced in step (B) and the thickness c of the film produced in step (C) satisfy the relationship b>c.

2) In the process for producing a synthetic resin film according to item 1), heating in step (C) is performed under a tension of 0.10 kg/mm² to 1.50 kg/mm² in the machine direction (MD) of the film.

3) In the process for producing a synthetic resin film according to item 1) or 2), heating in step (B) is performed at a maximum atmospheric temperature of 450° C. or lower.

4) In the process for producing a synthetic resin film according to any one of items 1) to 3), heating in step (B) is performed by treatment with hot air.

5) In the process for producing a synthetic resin film according to any one of items 1) to 3), heating in step (B) is performed by treatment with radiant heat rays.

6) In the process for producing a synthetic resin film according to any one of items 1) to 3), heating in step (B) is performed by a combination of hot air treatment and radiant heat rays treatment.

7) In the process for producing a synthetic resin film according to any one of items 1) to 6), heating in step (C) is performed at an atmospheric temperature of 430° C. or higher.

8) In the process for producing a synthetic resin film according to any one of items 1) to 7), heating in step (C) is performed by treatment with hot air.

9) In the process for producing a synthetic resin film according to any one of items 1) to 7), heating in step (C) is performed by treatment with radiant heat rays.

10) In the process for producing a synthetic resin film according to any one of items 1) to 7), heating in step (C) is performed by a combination of hot air treatment and radiant heat rays treatment.

11) In the process for producing a synthetic resin film according to any one of items 1) to 7), heating in step (C) is performed by simultaneous treatment with hot air and radiant heat rays.

12) In the process for producing a synthetic resin film according to any one of items 1) to 11), the synthetic resin film is a polyimide film.

13) A process for producing a synthetic resin film according to the present invention includes at least the following steps (A) to (C):

(A) a step of casting and applying a composition containing a polymer and an organic solvent onto a support to form a gel film;

(B) a step of stripping the gel film and heating the gel film with both ends being fixed; and

(C) a step of heating the film with both ends being released after step (B),

wherein the heating temperature in step (B) is higher than that in step (C).

14) In the process for producing a synthetic resin film according to item 13), heating in step (B) is performed at a maximum atmospheric temperature of 450° C. or lower.

15) In the process for producing a synthetic resin film according to item 13) or 14), heating in step (C) is performed at an atmospheric temperature of 430° C. or higher.

In the process for producing a synthetic resin film according to any one of items 13) to 15), the synthetic resin film is a polyimide film.

According to the present invention, it is possible to continuously produce a synthetic resin film having controlled orientation in the machine direction across the full width.

### BRIEF DESCRIPTION OF THE DRAWINGS

FIGS. 1 and 2 each show an embodiment of a process for heating a film with free ends under a tension.

FIGS. 3 and 4 each show an exemplary hot-air furnace.

FIGS. 5 and 6 each show an exemplary radiant heating furnace.

FIGS. 7 and 8 each show an exemplary furnace capable of simultaneously applying hot air and radiant heat rays to a film.

FIG. 9 is a schematic view illustrating the definition of a molecular orientation angle S.

FIG. 10 shows positions where the molecular orientation angles are measured.

FIG. 11 shows a specific experiment of applying heat and/or tension to a film with ends fixed.

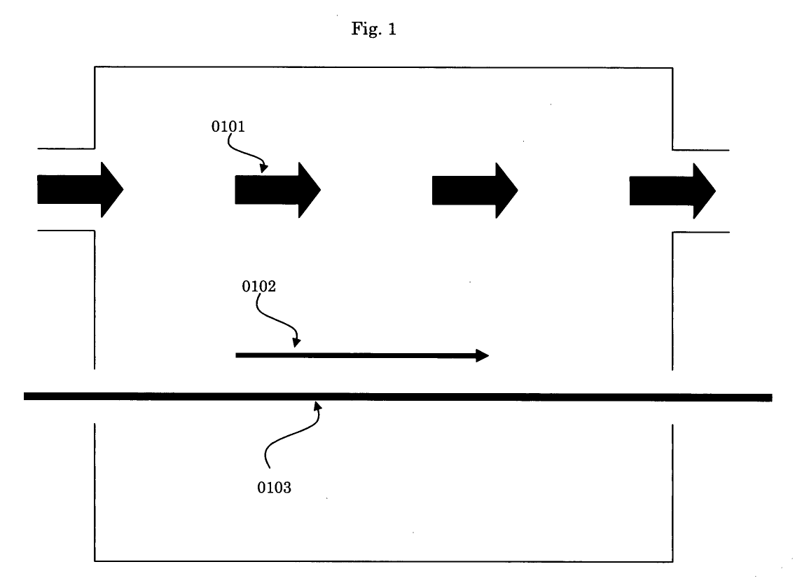

In FIG. 1, reference numeral 0101 represents hot air, reference numeral 0102 represents the traveling direction of a film, and reference numeral 0103 represents a film.

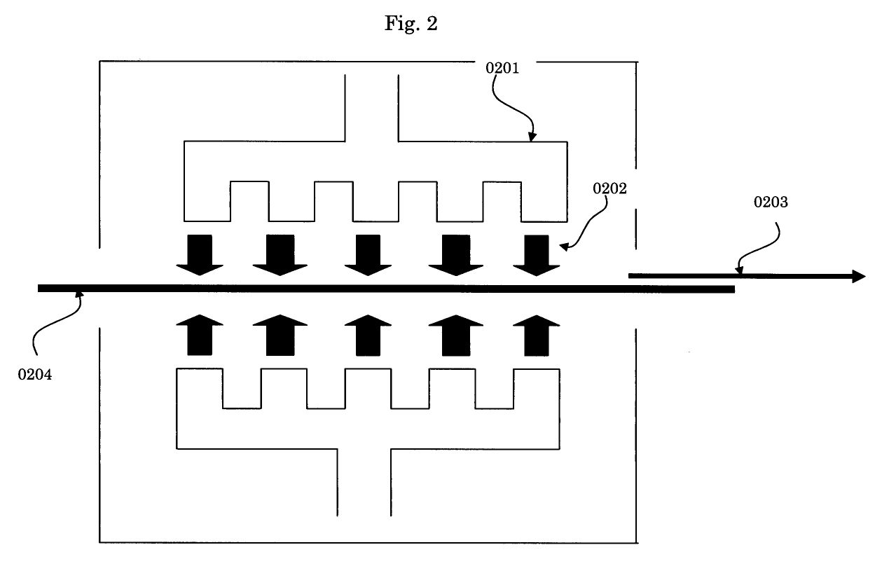

In FIG. 2, reference numeral 0201 represents a jet nozzle, reference numeral 0202 represents hot air, reference numeral 0203 represents the traveling direction of a film, and reference numeral 0204 represents a film e.

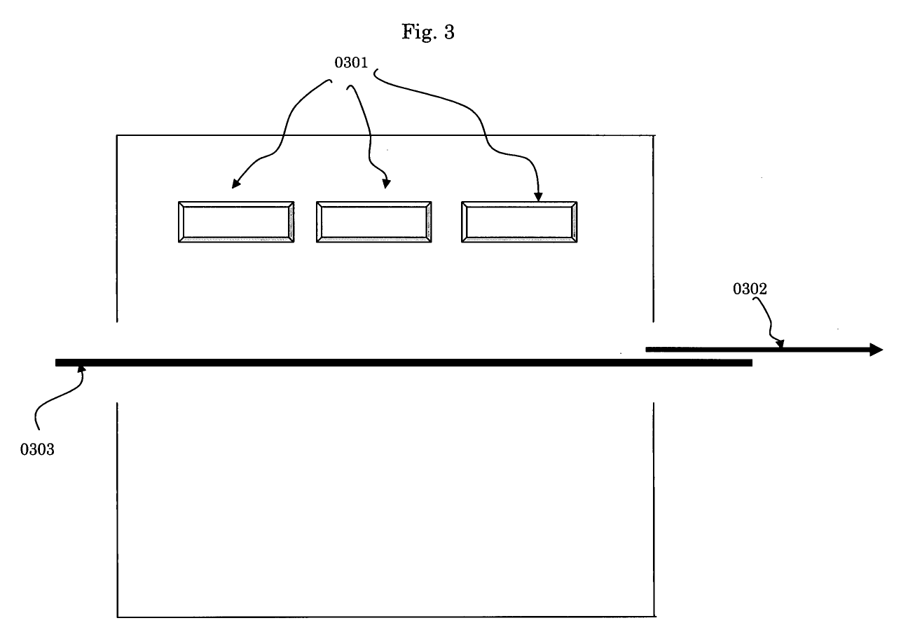

In FIG. 3, reference numeral 0301 represents a radiant heater, reference numeral 0302 represents the traveling direction of a film, and reference numeral 0303 represents a film.

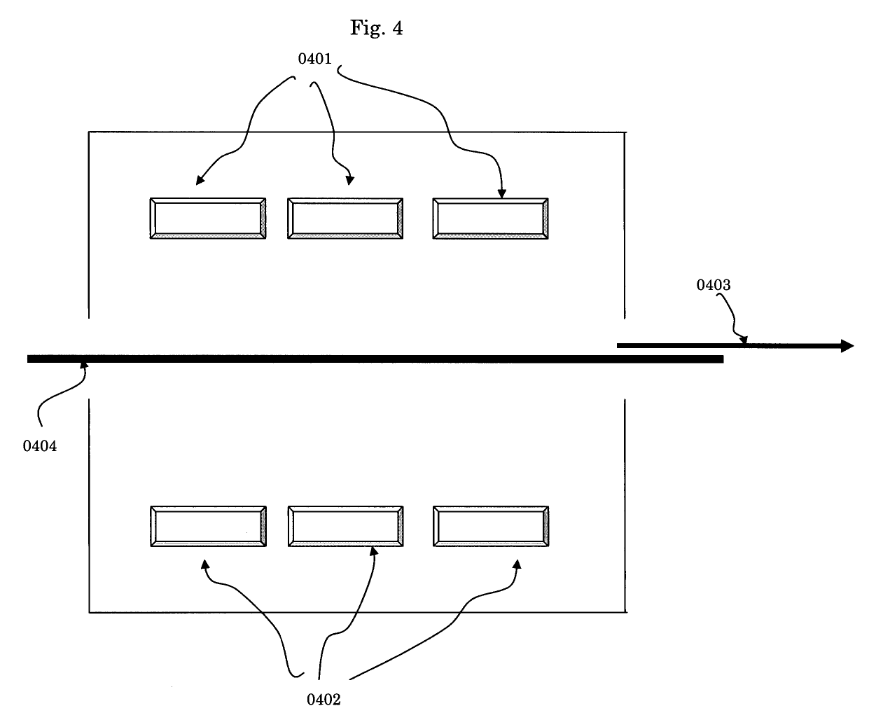

In FIG. 4, reference numerals 0401 and 0402 each represent a radiant heater, reference numeral 0403 represents the traveling direction of a film, and reference numeral 0404 represents a film.

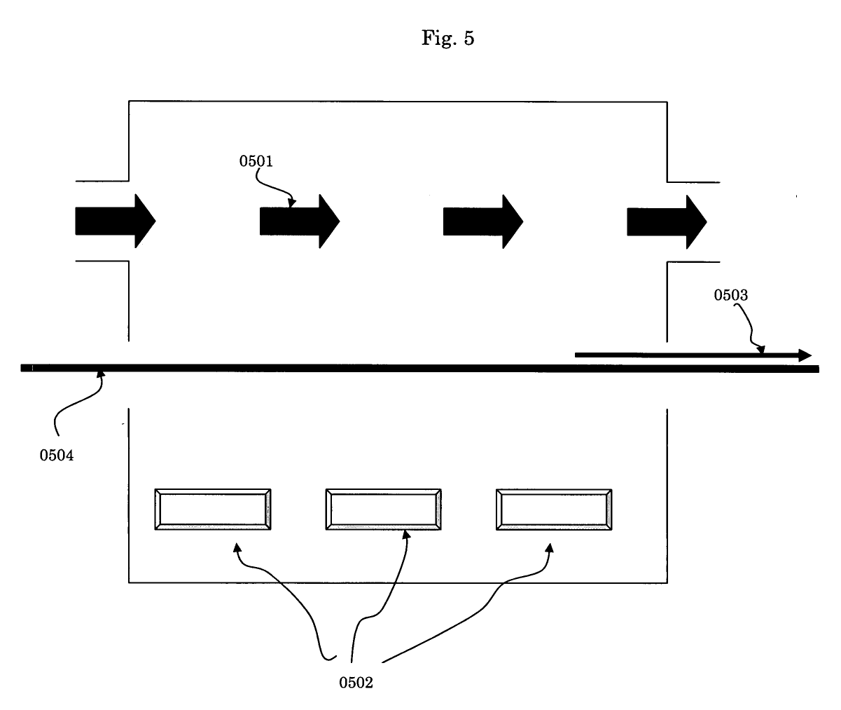

In FIG. 5, reference numeral 0501 represents hot air, reference numeral 0502 represents a radiant heater, reference numeral 0503 represents the traveling direction of a film, and reference numeral 0504 represents a film.

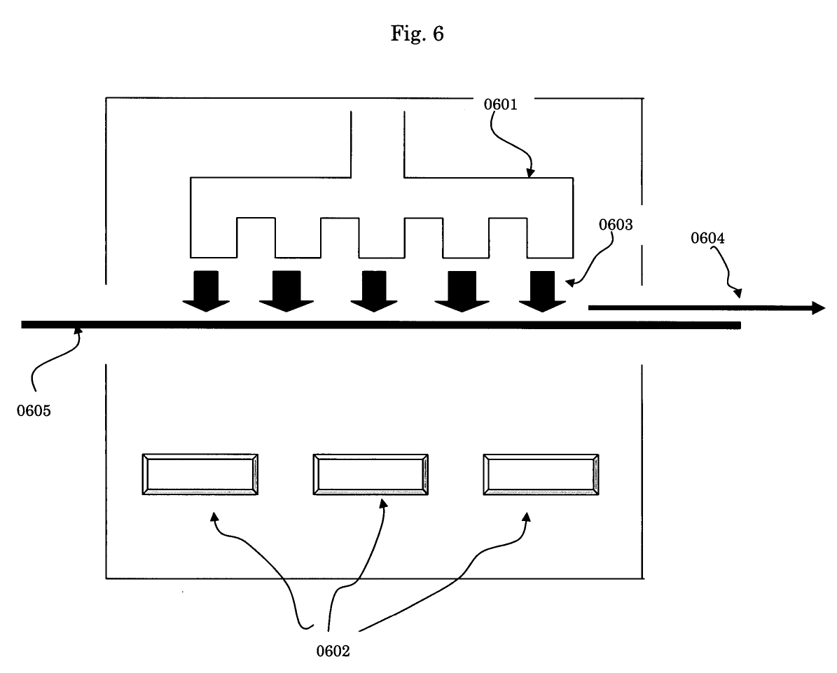

In FIG. 6, reference numeral 0601 represents a jet nozzle, reference numeral 0602 represents a radiant heater, reference numeral 0603 represents hot air, reference numeral 0604 represents the traveling direction of a film, and reference numeral 0605 represents a film s.

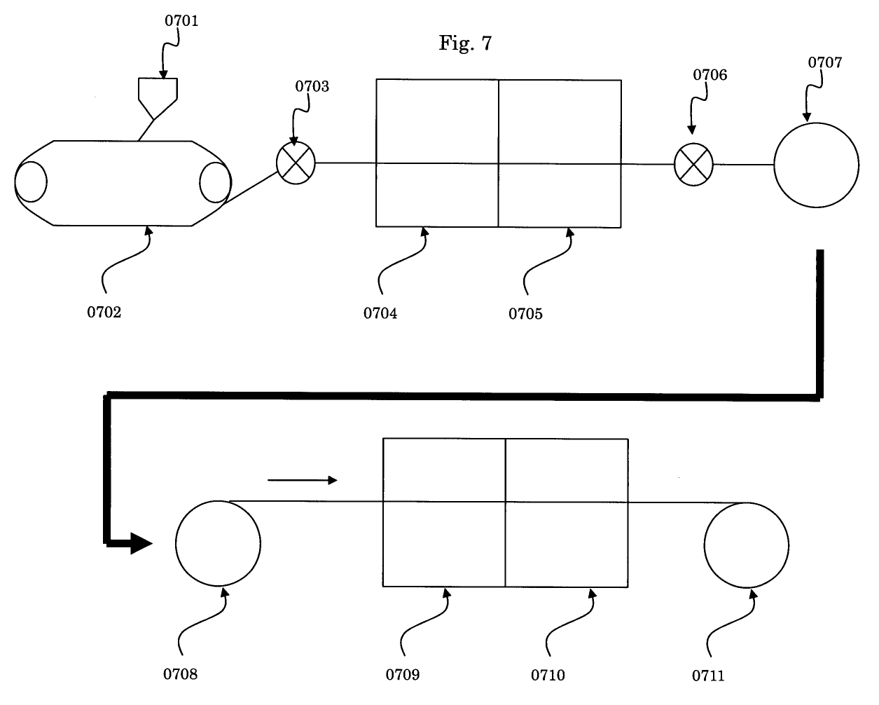

In FIG. 7, reference numeral 0701 represents a die, reference numeral 0702 represents a belt, reference numeral 0703 represents a unit for fixing both ends of a gel film stripped from the belt, reference numeral 0704 represents a hot-air furnace, reference numeral 0705 represents a radiant heating furnace, reference numeral 0706 represents a unit for releasing both fixed ends of the film, reference numeral 0707 represents a unit for winding the film after step (B), reference numeral 0708 represents a unit for unwinding the film after step (B), reference numeral 0709 represents a hot-air furnace, reference numeral 0710 represents a radiant heating furnace, and reference numeral 0711 represents a unit for winding the film after step(C).

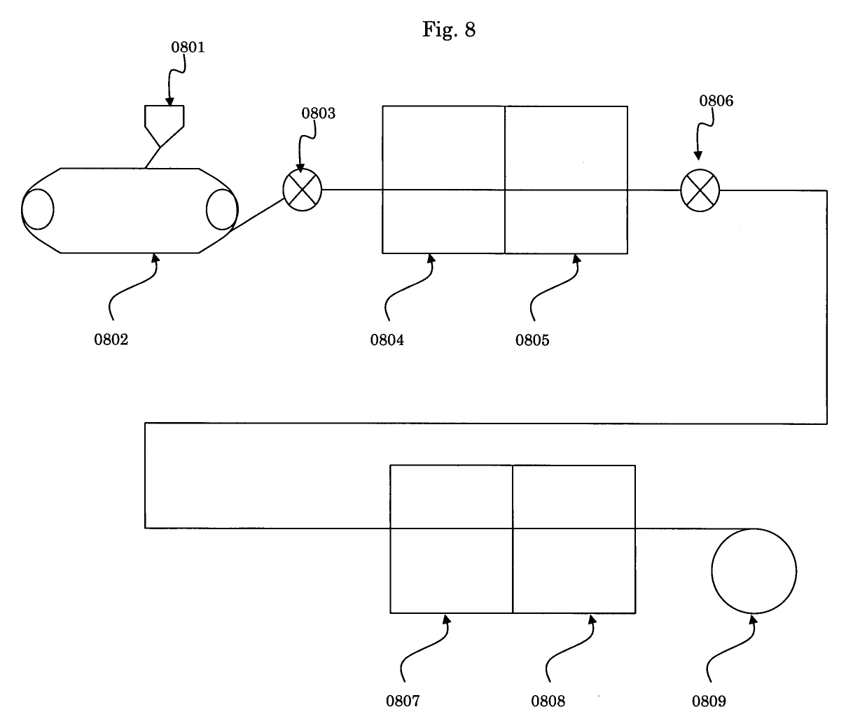

In FIG. 8, reference numeral 0801 represents a die, reference numeral 0802 a belt, reference numeral 0803 represents a unit for fixing both ends of the film stripped from the belt, reference numeral 0804 represents a hot-air furnace, reference numeral 0805 represents a radiant heating furnace, reference numeral 0806 represents a unit for releasing both fixed ends of the film, reference numeral 0807 represents a hot-air furnace, reference numeral 0808 represents a radiant heating furnace, and reference numeral 0809 represents a unit for winding the film after step (C).

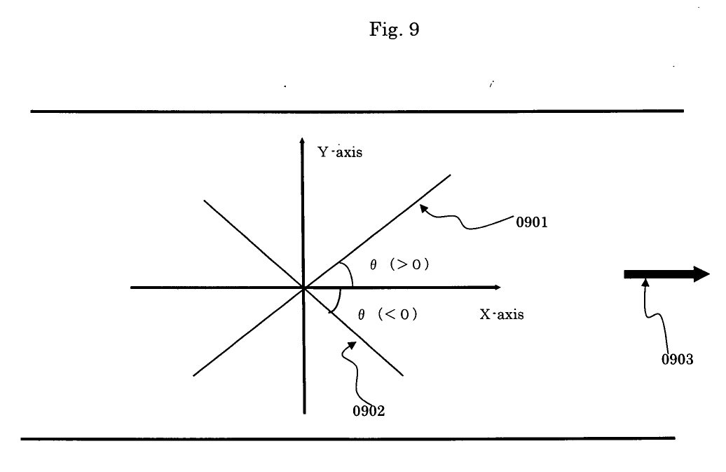

In FIG. 9, reference numerals 0901 and 0902 each represent the orientation axis and reference numeral 0903 represents the traveling direction (machine direction (MD)) in casting polyamic acid onto a support.

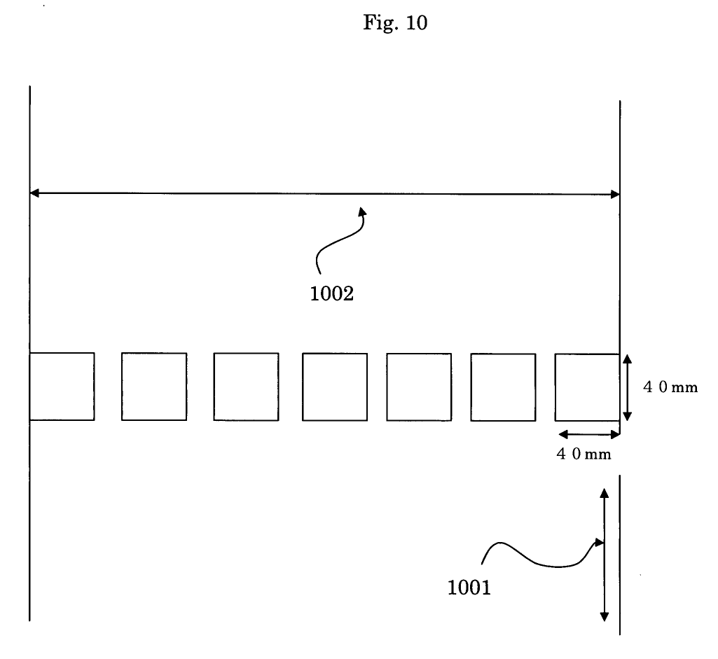

In FIG. 10, reference numeral 1001 represents the machine direction (MD) (traveling direction of the film) and reference numeral 1002 represents the transverse direction (TD) (width direction of the film).

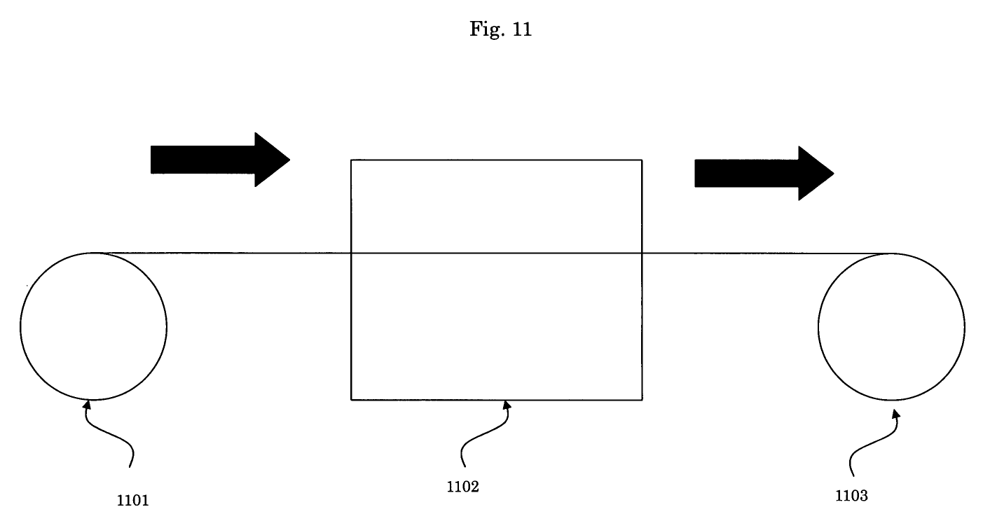

In FIG. 11, reference numeral 1101 represents a unit for unwinding a film, reference numeral 1102 represents a hot-air and far-infrared heating furnace, and reference numeral 1103 represents a unit for winding the film.

### BEST MODE FOR CARRYING OUT THE INVENTION

The present invention provides 1) a process for producing a synthetic resin film including at least the following steps (A) to (C): (A) a step of casting and applying a composition containing a polymer and an organic solvent onto a support to form a gel film; (B) a step of stripping the gel film and heating the gel film with both ends being fixed; and (C) a step of heating the film with both ends being released after step (B).

Step (A)

In step (A), a composition containing a polymer and an organic solvent is cast and applied onto a support, for example, an endless belt or a stainless drum, and then dried to form a self-supporting gel film. Examples of the polymer include, but are not limited to, polyimides, aromatic polyesters, liquid crystal polymers, polyamides, polyolefins, polyetherimides, polyesteramides, vinyl polymers, polyketones, polyphenylenesulfides, and polyethersulfones. A precursor of a polymer as a final product may also be used. An example thereof includes polyamic acid, which is a precursor of polyimide.

The term “gel film” of the present invention refers to a polymeric resin film produced by heating and drying an organic solution containing a polymer and an organic solvent, the polymeric resin film containing residual components such as the organic solvent and a reaction product. In producing a polyimide film, the resulting gel film contains residual components such as an organic solvent containing polyamic acid, a catalyst for imidization, a dehydrating agent, and a reaction product (for example, the absorbing component in the dehydrating agent and water).

The ratio of the residual components in the gel film, i.e., the residual-component ratio c (%), is calculated by the following formula (formula 1), based on a completely-dried synthetic-resin weight a (g) referring to the weight of a completely-dried synthetic resin in the gel film and a residual-component weight b (g) referring to the weight of the residual components. The residual-component ratio c is preferably 500% or less, more preferably 10% to 300%, and most preferably 20% to 100%.
c=b/a×100 (formula 1)
At a residual-component ratio c of 500% or more, a variation in residual-component weight in plane is relatively increased. Thus, it may be difficult to uniformly control the properties of the film.

The completely-dried synthetic-resin weight a and the residual-component weight b are determined as follows: A weight d of a gel film with a size of 100 mm×100 mm is measured. The gel film is dried in an oven at 450° C. for 20 minutes and cooled to room temperature. Then, the weight of the film is measured to determine the completely-dried synthetic-resin weight a. From the weight d of the gel film and the completely-dried synthetic-resin weight a, the residual-component weight b is calculated by the following formula: b=d−a

In the step of producing a gel film, a temperature, air velocity, and exhaust gas velocity during heating and drying the film on the support are preferably determined so that the residual-component ratio is in the above-described range. For example, a preferable drying temperature on the support is 200° C. or lower, and a preferable drying time is 20 seconds to 30 minutes.

Step (B)

Step (B) is a step of stripping a gel film obtained in step (A) and heating the film while both ends of the film are fixed with pins or clips.

With respect to the heating temperature in step (B), the maximum atmospheric temperature is preferably set at 450° C. or lower, more preferably 400° C. or lower, because a film having controlled molecular orientation across the full width can be provided. When heating is performed by treatment with radiant heat rays, the term “atmospheric temperature” refers to the temperature near the film traveling in a radiant heating furnace. For heating by treatment with hot air, the term refers to the temperature of the circulating hot air.

In step (B), the heating is preferably performed with hot air or radiant heat rays because a film can be uniformly heated in the width direction (transverse direction). In addition, the heating is preferably performed with a combination of hot air and radiant heat rays because a film can be uniformly heated in the width direction (transverse direction). When hot-air heating is employed in step (B), the hot-air heating is preferably performed at 450° C. or lower, more preferably 400° C. or lower. When the heating with radiant heating rays is employed, the heating with radiant heating rays is preferably performed at 430° C. or lower, more preferably 400° C. or lower.

In the hot-air heating, when a hot-air furnace is used for exposing a film to the hot air, any hot-air furnaces, for example, the hot-air furnaces as shown in FIGS. 1 and 2 may be used. In the heating with radiant heat rays, there are various processes for exposing a film to the radiant heat rays. For example, when a radiant heating furnace is used, any radiant heating furnaces, for example, the radiant heating furnaces as shown in FIGS. 3 and 4 may be used. Any radiant heat rays may be used. Examples thereof include infrared rays and far-infrared rays. The hot-air furnaces or the radiant heating furnaces as shown in FIGS. 1 to 4 may be used for exposing a film to the hot air or radiant heat rays. These may be used alone or in combination. Alternatively, the furnaces as shown in FIGS. 5 and 6 may be used for exposing a film to the hot air and radiant heat rays at the same time.

The heating temperature in step (B) is preferably equal to or lower than that in step (C) described below because a film oriented in the machine direction can be obtained.

Step (C)

Step (C) is a step of heating the film with both ends released by, for example, stripping the film from the pins or clips fixing the ends of the film after step (B).

The tension in step (C) is preferably set at 0.10 to 1.50 kg/mm² in the machine direction. At a tension of 0.10 kg/mm² or less, the film is sometimes not oriented in the machine direction. At a tension of 1.5 kg/mm² or more, the flatness of the film may be impaired. The tension is preferably set at 0.20 to 1.0 kg/mm², more preferably 0.20 to 0.80 kg/mm².

With respect to the heating temperature in step (C), a maximum atmospheric temperature is preferably set at 430° C. or higher, more preferably 450° C. or higher. At a maximum atmospheric temperature below 430° C., the effect of orienting the film in the machine direction is not satisfactorily achieved; hence, a film oriented in the machine direction across the full width is sometimes not obtained.

In step (C), the heating is preferably performed with hot air or radiant heat rays because a film can be uniformly heated in the width direction (transverse direction). In addition, the heating is preferably performed with a combination of hot air and radiant heat rays because a film can be uniformly heated in the width direction (transverse direction).

When hot-air heating is employed in step (C), the hot-air heating is preferably performed at 430° C. or higher, more preferably 450° C. to 570° C., most preferably 470° C. to 560° C. At a maximum atmospheric temperature below 430° C., in some cases, the effect of orienting the film in the machine direction is not satisfactorily achieved; hence, a film oriented in the machine direction across the full width may not be obtained. When the heating with radiant heating rays is employed, the heating with radiant heating rays is preferably performed 400° C. or higher, more preferably 430° C. to 570° C., most preferably 450° C. to 560° C. At a maximum atmospheric temperature below 400° C., in some cases, the effect of orienting the film in the machine direction is not satisfactorily achieved; hence, a film oriented in the machine direction across the full width may not be obtained.

In step (C), heating by concurrent use of the hot air and the radiant heat rays is preferable because a film can be uniformly heated in the width direction (transverse direction). In this case, the heating is preferably performed at 400° C. or higher, more preferably 430° C. to 570° C. At a maximum atmospheric temperature below 400° C., in some cases, the effect of orienting the film in the machine direction is not satisfactorily achieved; hence, a film oriented in the machine direction across the full width may not be obtained.

The hot-air furnaces for the hot-air heating and the radiant heating furnaces for the heating with radiant heat rays exemplified in step (B) may also be used in step (C). As shown in FIG. 7, after releasing the fixed ends of the film, the film is temporarily wound after step (B) and then step (C) may be performed (for example, step (C) is performed by feeding a film that has been wound after step (B) through a hot-air furnace and/or a radiant heating furnace having a film carrier capable of controlling tension by a roll-to-roll process). As shown in FIG. 8, step (C) subsequent to step (B) may be performed by, for example, a process for feeding a film without fixing the ends of the film with pins or the like through a furnace, such as the hot-air furnace and/or the radiant heating furnace.

The heating temperature in step (C) is preferably equal to or higher than that in step (B) because a film oriented in the machine direction can be obtained.

The present inventors found that a film oriented in the machine direction can be produced by controlling heating conditions in steps (B) and (C). Unlike the baked polyimide film obtained by the process disclosed in Patent document 2 in which imidization and removal of solvent are completed, the inventive film produced in step (B) is in a state before completion of imidization and solvent removal. Therefore, it is difficult to completely express the state of the inventive film in terms of, for example, the degree of imidization and the content of a residual component. The present inventors found that the state before completion of imidization and solvent removal can be expressed by the thickness of the film. The present inventors also found that the heating conditions (temperature, tension, and residence time) in each step should be set so as to satisfy the relationship:
b>c
where b represents a thickness of the film obtained in step (B), and c represents a thickness of the film obtained in step (C).

The thickness of a film is measured at 10 uniformly spaced points in the transverse direction in each of steps(B) and (C). The average thickness of the film produced in step (B) is defined as “b”. The average thickness of the film produced in step (C) is defined as “c”.

### Production Embodiment of Synthetic Resin Film

The production of a polyimide film will be specifically described. A process for producing polyamic acids, which function as precursors of polyimides used in step (A), will now be described. Polyamic acids can be produced by known processes. Polyamic acids are usually produced by the following process: substantially equimolar amounts of at least one aromatic acid dianhydride and at least one diamine compound are dissolved in an organic solvent. The resulting organic solution is stirred under a controlled temperature until the polymerization of the aromatic acid dianhydride with the diamine compound is completed. The resulting organic solution usually has a concentration of 5 to 35 percent by weight, preferably 10 to 30 percent by weight. In this range, an appropriate molecular weight of the polymer and viscosity of the solution can be achieved.

Any known polymerization process may be used. Examples of particularly preferable polymerization process include:
1) a polymerization process in which a diamine compound is dissolved in a polar organic solvent, and then the resulting solution is allowed to react with a substantially equimolar aromatic tetracarboxylic dianhydride;
2) a polymerization process in which an aromatic tetracarboxylic dianhydride is allowed to react with a less than equimolar amount of a diamine compound in a polar organic solvent to form a prepolymer containing acid anhydride groups at both termini, and then the diamine compound is added so that the total amount of diamine compound is substantially equimolar to the amount of aromatic tetracarboxylic dianhydride;
3) a polymerization process in which an aromatic tetracarboxylic dianhydride is allowed to react with an excessive molar amount of a diamine compound in a polar organic solvent to form a prepolymer containing amino groups at both termini, and then the diamine compound is further added, and then the aromatic tetracarboxylic dianhydride is added so that the total amount of aromatic tetracarboxylic dianhydride is substantially equimolar to the amount of diamine compound;
4) a polymerization process in which an aromatic tetracarboxylic dianhydride is dissolved and/or dispersed in a polar organic solvent, and then allowed to react with a substantially equimolar amount of a diamine compound; and
5) a polymerization process in which a mixture of a substantially equimolar aromatic tetracarboxylic dianhydride and diamine compound is allowed to react in a polar organic solvent.

Examples of the diamine compound include, but are not limited to, aromatic diamines such as 4,4′-diaminodiphenylpropane, 4,4′-diaminodiphenylmethane, benzidine, 3,3′-dichlorobenzidine, 4,4′-diaminodiphenylsulfide, 3,3′-diaminodiphenyl sulfone, 4,4′-diaminodiphenyl sulfone, 4,4′-oxydianiline (4,4′-diaminodiphenyl ether), 3,3′-oxydianiline (3,3′-diaminodiphenyl ether), 3,4′-oxydianiline (3,4′-diaminodiphenyl ether), 1,5-diaminonaphthalene, 4,4′-diaminodiphenyldiethylsilane, 4,4′-diaminodiphenylsilane, 4,4′-diaminodiphenylethylphosphine oxide, 4,4′-diaminodiphenyl N-methylamine, 4,4′-diaminodiphenyl N-phenylamine, 1,4-diaminobenzene (p-phenylenediamine), 1,3-diaminobenzene (m-phenylenediamine), 1,2-diaminobenzene (o-phenylenediamine), and their analogues; aliphatic diamines; and alicyclic diamines. These may be used alone. A mixture containing these in a desired ratio may also be used. Among these, in particular, p-phenylenediamine and/or 4,4′-diaminodiphenyl ether can be suitably used as the diamine component. The above-described diamine compounds are preferable because polyimide films produced with the diamine compounds are rigid, thereby facilitating the control of orientation.

Examples of the aromatic acid dianhydride include, but are not limited to, 2,3,6,7-naphthalenetetracarboxylic dianhydride, 1,2,5,6-naphthalenetetracarboxylic dianhydride, 2,2′,3,3′-biphenyltetracarboxylic dianhydride, 2,2-bis(3,4-dicarboxyphenyl)propane dianhydride, 3,4,9,10-perylenetetracarboxylic dianhydride, bis(3,4-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)ethane dianhydride, oxydiphthalic dianhydride, bis(3,4-dicarboxyphenyl)sulfone dianhydride, ethylenebis(trimellitic acid monoester anhydride), and bisphenol A bis(trimellitic acid monoester anhydride) and their analogues. These may be used alone. A mixture containing these in a desired ratio may also be used. Examples of the aromatic acid dianhydride include pyromellitic dianhydride, 3,3′,4,4′-biphenyltetracarboxylic dianhydride, 3,3′,4,4′-benzophenonetetracarboxylic dianhydride, and p-phenylenebis(trimellitic acid monoester anhydride). These may be used alone. A mixture containing these in a desired ratio may also be used. To control the molecular orientation axis, the dianhydride component containing at least one selected from the group consisting of pyromellitic dianhydride, 3,3′,4,4′-biphenyltetracarboxylic dianhydride, 3,3′,4,4′-benzophenonetetracarboxylic dianhydride, and p-phenylenebis(trimellitic acid monoester anhydride) is preferable because a polyimide film produced has a rigid structure, thereby facilitating the control of the orientation.

Examples of a preferable solvent used for preparing polyamic acid include amides such as N,N-dimethylformamide, N,N-dimethylacetamide, and N-methyl-2-pyrrolidone. In particular, N,N-dimethylformamide and N,N-dimethylacetamide may be preferably used.

The polyimide film may be produced from the polyamic acid solution by a known process, such as thermal imidization or chemical imidization. The thermal imidization means a process for accelerating imidization by heating alone without a dehydrating agent or an imidization catalyst. Heating conditions can be changed depending on the type of polyamic acid, a film thickness, and the like. The chemical imidization means a process in which an organic solution containing polyamic acid is allowed to react in the presence of a dehydrating agent and an imidization catalyst. Examples of the dehydrating agent include aliphatic acid anhydrides such as acetic anhydride; and aromatic acid anhydrides such as benzoic anhydride. Examples of the imidization catalyst include aliphatic tertiary amines such as triethylamine; aromatic tertiary amines such as dimethylaniline; and heterocyclic tertiary amines such as pyridine, picoline, and isoquinoline. Among these, in particular, acetic anhydride is particularly preferable as the dehydrator. Isoquinoline is particularly preferable as the imidization catalyst. To obtain an excellent polyimide film, 1.0 to 4.0, preferably 1.2 to 3.5, more preferably 1.5 to 2.5 moles of acetic anhydride is added per mole of amic acid in an organic solution containing polyamic acid. To obtain an excellent polyimide film, 0.1 to 2.0, preferably 0.2 to 1.5, more preferably 0.3 to 1.2, most preferably 0.3 to 1.1 moles of isoquinoline is added per mole of amic acid in an organic solution containing polyamic acid. For example, imidization in a short time after mixing polyamic acid, a dehydrator, and an imidization catalyst may cause poor fluidity in a die and breaking of the film while the film is transferring in a tenter furnace.

A composition containing a polyamic acid solution produced as above or a composition containing a polyamic acid solution and a mixture of a dehydrator and an imidization catalyst is cast and applied on a support such as an endless belt or a stainless drum and dried to form a self-supporting gel film. Drying on the support is preferably performed at 200° C. or lower for 20 seconds to 30 minutes.

Next, the film is stripped from the support. As described above, subsequently, both ends of the film are fixed with pins or the like, and then the film is heated while being transferred. Furthermore, the fixed ends of the film are released, and then the film is heated as described above to form a target film oriented in the machine direction.

According to the above-described production process, a film having molecular orientation controlled in the machine direction can be produced. Molecular orientation controlled in the machine direction can be determined by measuring a molecular orientation angle. As long as the molecular orientation angle is in the range of −30° to 30°, preferably −20° to 20°, more preferably −15° to 15°, a film having excellent dimensional stability after etching and thus functioning as a base film for a FPC can be produced.

The present invention is not limited to these embodiments. Various improvements, changes, and modifications may be made by those skilled in the art without departing from the purport of the invention.

### EXAMPLES

Although the invention will be specifically described by Examples, these examples do not limit the scope of the invention. The molecular orientation angles in Examples and Comparative Examples are rated as follows. Table 1 provides a summary of production conditions for Examples and Comparative Examples.

(Molecular Orientation Angle of Film)

Samples each having a size of 4 cm×4 cm were cut out from a film and measured with a microwave molecular orientation analyzer (MOA2012A manufactured by Oji Scientific Instruments).

The molecular orientation angle θ is defined as follows.

The direction of molecular orientation in the film plane can be determined as an angle using MOA2012, the direction being defined as the maximum bearing of ε′, where ε′ is a dielectric constant of the sample. In the present invention, a line indicating the direction of orientation is defined as an “orientation axis” of the sample.

As shown in FIG. 9, the x-axis lies at the center of a film and is in the machine direction (MD direction) of the film. The line direction of polyamic acid cast onto a support is defined as the positive direction. An angle defined by the positive direction of x-axis and the orientation axis measured as described above is defined as an orientation axis angle θ. When the orientation axis lies in the first and third quadrants, the orientation axis angle is defined as being positive (0°<θ<90°). When the orientation axis is present in the second and fourth quadrants, the orientation axis angle is defined as being negative (−90°≦θ<0°).

The production examples of a film after step (B) (hereinafter, also referred to as “end-fixed film”) and a film after step (C) (hereinafter, also referred to as “free end film”) are described below.

(Measurement of Thickness)

The thickness of the film is measured at 10 uniformly spaced points in the transverse direction. The average of the observed thicknesses is defined as the film thickness. MT12 (manufactured by Heidenhain corporation, Germany) was used for the measurement.

### Production Example 1 of End-Fixed Film

A pyromellitic dianhydride/4,4′-oxydianiline/p-phenylenediamine (1/0.75/0.25, molar ratio) mixture was polymerized in N,N′-dimethylacetamide solvent so that the solid content was 18%. Specifically, 75 mol % of 4,4′-oxydianiline for the total amount of diamine component was dissolved in N,N′-dimethylacetamide solvent. Then, the total amount of pyromellitic dianhydride was added. That is, 133% of acid anhydride for the amount of diamine component that had already been added was added, thus producing an acid-terminated prepolymer. Subsequently, the remaining diamine component, i.e., p-phenylenediamine was added to the acid-terminated prepolymer solution so that the amount of diamine component added was substantially equimolar to the total amount of acid component. The resulting mixture was allowed to react, thus yielding a polymeric solution.

This polymeric solution was cooled to about 0° C. Then, 2.0 mol of acetic anhydride and 0.5 mol of isoquinoline were added per 1 mol of amic acid in the polyamic acid organic solution cooled at about 0° C. The mixture was adequately stirred. The mixture was cast and applied onto an endless belt by extruding through a die so that the film had a thickness of 25 μm after being dried and baked. The applied solution was heated at 85° C. for about 4 minutes on the endless belt to produce a gel film, the content of volatile components of the gel film being 50 percent by weight. The resulting gel film was stripped. Subsequently, both ends of the film were fixed on a pin seat for continuously carrying the film. The film with both ends being fixed was carried into a hot-air furnace as shown in FIG. 4 and heated at 300° C. for 30 seconds. Subsequently, the film was carried into hot-air furnaces maintaining temperatures of 340° C. and 370° C. and heated for 30 seconds, respectively. Next, the film was heated at 350° C. for 30 seconds with a far-infrared heating furnace which uses far-infrared rays as a radiant heat source, as shown in FIG. 5. When the film was carried from the far-infrared heating furnace to the exterior, the film was stripped from the pins and wound to obtain an end-fixed film (long film) having a thickness of 25 μm and a width of about 1 m.

### Production Example 2 of End-Fixed Film

A pyromellitic dianhydride/p-phenylenebis(trimellitic acid monoester anhydride)/4,4′-diaminodiphenyl ether/p-phenylenediamine (0.50/0.50/0.50/0.50, molar ratio) mixture was polymerized in N,N′-dimethylacetamide solvent so that the solid content was 18%. Specifically, 50 mol % of 4,4′-diaminodiphenyl ether for the total amount of diamine component and 50 mol % of p-phenylenediamine for the total amount of diamine component were dissolved in N,N′-dimethylacetamide solvent. Then, 50 mol % of p-phenylenebis(trimellitic acid monoester anhydride) for the total amount of acid dianhydride was added to produce an amine-terminated prepolymer. Subsequently, the remaining acid dianhydride component, i.e., pyromellitic dianhydride was added to the amine-terminated prepolymer so that the amount of the acid dianhydride added was substantially equimolar to the total amount of acid component. The resulting mixture was allowed to react, thus yielding a polymeric solution.

This polymeric solution was cooled to about 0° C. Then, 2.1 mol of acetic anhydride and 1.1 mol of isoquinoline were added per 1 mol of amic acid in the polyamic acid organic solution cooled at about 0° C. The resulting mixture was adequately stirred. The mixture was cast and applied onto an endless belt by extruding through a die so that the film had a thickness of 25 μm after being dried and baked. The applied solution was heated at 85° C. for about 4 minutes on the endless belt to produce a gel film, the content of volatile components of the gel film being 50 percent by weight. The resulting self-supporting gel film was stripped. Subsequently, both ends of the film were fixed on a pin seat for continuously carrying the film. The film with both ends being fixed was carried into a hot-air furnace as shown in FIG. 4 and heated at 350° C. for 60 seconds. Subsequently, the film was carried into hot-air furnaces maintaining temperatures of 400° C. and 450° C. and heated for 30 seconds, respectively. Next, the film was heated at 410° C. for 30 seconds with a far-infrared heating furnace as shown in FIG. 5. When the film was carried from the far-infrared heating furnace to the exterior, the film was stripped from the pins and wound to obtain an end-fixed film (long film) having a thickness of 18 μm and a width of about 1 m.

### Production Example 3 of End-Fixed Film

A film was produced as in Production example 2 of end-fixed film until the heating with the hot-air furnaces had been performed. Then, the film was heated at 520° C. for 30 seconds with a far-infrared heating furnace as shown in FIG. 5. When the film was carried from the far-infrared heating furnace to the exterior, the film was stripped from the pins and wound to obtain an end-fixed film (long film) having a thickness of 18 μm and a width of about 1 m.

### Example 1

The end-fixed film produced according to Production example 1 of an end-fixed film was carried into a hot-air furnace as shown in FIG. 1 and heated and then wound while the tension was controlled by a roll-to-roll process as shown in FIG. 11, thus producing a free end film. The production conditions were described as follows: residence time in the furnace, 30 seconds; furnace temperature, 470° C.; and tension 0.51 kg/mm².

As shown in FIG. 10, 7 samples each having a size of 4 cm×4 cm were cut out from a film at regular intervals in the width direction including both ends. Molecular orientation angles were then measured. In addition, changes in thicknesses before and after the treatment for the film were measured. Table 2 shows the results.

### Example 2

The molecular orientation angles of a film were determined as in Example 1, except that the film was carried into a far-infrared heating furnace as shown in FIG. 4 and heated at 500° C. and then wound. In addition, changes in thicknesses before and after the treatment for the film were measured. Table 2 shows the results.

### Example 3

The molecular orientation angles of a film were determined as in Example 2, except that the tension was changed to 0.24 kg/mm². In addition, changes in thicknesses before and after the treatment for the film were measured. Table 2 shows the results.

### Example 4

The end-fixed film produced according to Production example 1 of an end-fixed film was carried into hot-air and far-infrared heating furnaces as shown in FIG. 8 and heated and then wound while the tension was controlled by a roll-to-roll process as shown in FIG. 11, thus producing a free end film. The production conditions were described as follows: residence time in the furnace, 45 seconds; furnace temperature, 460° C.; and tension 0.32 kg/mm². Thereafter, the molecular orientation angles of the film were determined as in Example 1. In addition, changes in thicknesses before and after the treatment for the film were measured. Table 2 shows the results.

### Example 5

The molecular orientation angles of a film were determined as in Example 4, except that the tension was set at 0.51 kg/mm². In addition, changes in thicknesses before and after the treatment for the film were measured. Table 2 shows the results.

### Example 6

The molecular orientation angles of a film were determined as in Example 4, except that the furnace temperature was set at 510° C. In addition, changes in thicknesses before and after the treatment for the film were measured. Table 2 shows the results.

### Example 7

The molecular orientation angles of a film were determined as in Example 5, except that the furnace temperature was set at 510° C. In addition, changes in thicknesses before and after the treatment for the film were measured. Table 2 shows the results.

### Example 8

The molecular orientation angles of a film were determined as in Example 6, except that the tension was set at 0.74 kg/mm². In addition, changes in thicknesses before and after the treatment for the film were measured. Table 2 shows the results.

### Example 9

The end-fixed film produced according to Production example 2 of an end-fixed film was carried into a hot-air furnace as shown in FIG. 4 and heated and then wound while the tension was controlled by a roll-to-roll process as shown in FIG. 11, thus producing a free end film. The production conditions were described as follows: residence time in the furnace, 30 seconds; furnace temperature, 470° C.; and tension 0.71 kg/mm². Thereafter, the molecular orientation angles were determined as in Example 1. In addition, changes in thicknesses before and after the treatment for the film were measured. Table 2 shows the results.

### Example 10

The end-fixed film produced according to Production example 2 of an end-fixed film was carried into a far-infrared heating furnace as shown in FIG. 6 and heated and then wound while the tension was controlled by a roll-to-roll process as shown in FIG. 11, thus producing a free end film. The production conditions were described as follows: residence time in the furnace, 30 seconds; furnace temperature, 500° C.; and tension 0.34 kg/mm². Thereafter, the molecular orientation angles were determined as in Example 1. In addition, changes in thicknesses before and after the treatment for the film were measured. Table 2 shows the results.

### Example 11

The molecular orientation angles of a film were determined as in Example 2, except that the film was heated with the far-infrared heating furnace having a temperature of 430° C. as shown in FIG. 6. In addition, changes in thicknesses before and after the treatment for the film were measured. Table 2 shows the results.

### Example 12

The long, low-temperature baked film produced according to Production example 1 of an end-fixed film was carried into hot-air and far-infrared heating furnaces as shown in FIG. 8 and heated and then wound while the tension was controlled by a roll-to-roll process as shown in FIG. 11, thus producing a free end film. The production conditions were described as follows: residence time in the furnace, 45 seconds; furnace temperature, 470° C.; and tension 0.10 kg/mm². Thereafter, the molecular orientation angles of the film were determined as in Example 1. In addition, changes in thicknesses before and after the treatment for the film were measured. Table 2 shows the results.

### Comparative Example 1

From a film produced according to Production example 1 of an end-fixed film, 7 samples each having a size of 4 cm×4 cm were cut out at regular intervals in the width direction including both ends of the film as shown in FIG. 10. Molecular orientation angles were then measured as described above. Table 2 shows the results.

### Comparative Example 2

From a film produced according to Production example 2 of an end-fixed film, 7 samples each having a size of 4 cm×4 cm were cut out at regular intervals in the width direction including both ends of the film as shown in FIG. 10. Molecular orientation angles were then measured as described above. Table 2 shows the results.

### Comparative Example 3

From a film produced according to Production example 3 of an end-fixed film, 7 samples each having a size of 4 cm×4 cm were cut out at regular intervals in the width direction including both ends of the film as shown in FIG. 10. Molecular orientation angles were then measured as described above. Table 2 shows the results.

TABLE 1

| | Condition in step (B) | | | | | |
|---|---|---|---|---|---|---|
| | Temperature in hot-air | | | | | |
| | furnace and far-infrared | | | | | |
| | heating furnace | | | | | |
| | Hot-air | | Condition in step (C) | | | |
| | furnace | Far-infrared | | | Residence | |
| | (maximum | heating | | Temperature | time of film | |
| | temperature) | furnace | Type of | in furnace | in furnace | Tension |
| | ° C. | ° C. | furnace | ° C. | Second | kg/mm² |
| EXAMPLE 1 | 370 | 350 | Hot-air | 470 | 30 | 0.51 |
| EXAMPLE 2 | 370 | 350 | Far-infrared | 500 | 30 | 0.51 |
| EXAMPLE 3 | 370 | 350 | Far-infrared | 500 | 30 | 0.24 |
| EXAMPLE 4 | 370 | 350 | Hot-air and | 460 | 45 | 0.32 |
| | | | far-infrared | | | |
| EXAMPLE 5 | 370 | 350 | Hot-air and | 460 | 45 | 0.51 |
| | | | far-infrared | | | |
| EXAMPLE 6 | 370 | 350 | Hot-air and | 510 | 45 | 0.32 |
| | | | far-infrared | | | |
| EXAMPLE 7 | 370 | 350 | Hot-air and | 510 | 45 | 0.51 |
| | | | far-infrared | | | |
| EXAMPLE 8 | 370 | 350 | Hot-air and | 510 | 45 | 0.74 |
| | | | far-infrared | | | |
| EXAMPLE 9 | 450 | 410 | Hot-air | 470 | 30 | 0.71 |
| EXAMPLE 10 | 450 | 410 | Far-infrared | 500 | 30 | 0.34 |
| EXAMPLE 11 | 370 | 350 | Far-infrared | 430 | 30 | 0.51 |
| COMPARATIVE | 370 | 350 | — | — | — | — |
| EXAMPLE 1 | | | | | | |
| COMPARATIVE | 450 | 410 | — | — | — | — |
| EXAMPLE 2 | | | | | | |
| COMPARATIVE | 450 | 520 | — | — | — | — |
| EXAMPLE 3 | | | | | | |
| EXAMPLE 12 | 370 | 350 | Hot-air and | 470 | 45 | 0.10 |
| | | | far-infrared | | | |

TABLE 2

| | | | | | | | | | Thickness |
|---|---|---|---|---|---|---|---|---|---|
| | | | | | | | | Initial | after |
| | Measurements | | | | | | | thickness | treatment |
| | Molecular orientation angle | | | | | | | (b) | (c) |
| | ° | | | | | | | μm | μm |
| EXAMPLE 1 | 0 | 0 | 1 | 0 | 0 | −1 | 0 | 25.0 | 24.7 |
| EXAMPLE 2 | −2 | −1 | −3 | −2 | 1 | 2 | 1 | 25.1 | 24.5 |
| EXAMPLE 3 | 5 | 0 | −6 | 2 | 4 | 0 | −3 | 25.0 | 24.8 |
| EXAMPLE 4 | −1 | 1 | 0 | 2 | 0 | 2 | 1 | 25.0 | 24.8 |
| EXAMPLE 5 | −1 | 0 | −2 | −3 | 0 | 3 | 1 | 25.0 | 24.6 |
| EXAMPLE 6 | −1 | 0 | −1 | −2 | 1 | 2 | 1 | 25.0 | 24.6 |
| EXAMPLE 7 | 1 | −1 | 0 | −2 | 0 | 1 | 1 | 25.0 | 24.3 |
| EXAMPLE 8 | 1 | −1 | −3 | −3 | 1 | 0 | 3 | 25.0 | 23.9 |
| EXAMPLE 9 | −9 | −10 | −8 | −9 | 7 | 5 | 8 | 18.0 | 24.4 |
| EXAMPLE 10 | −6 | −5 | −5 | −6 | 0 | 5 | 6 | 18.0 | 24.7 |
| EXAMPLE 11 | −15 | 7 | −12 | 8 | 10 | 13 | 14 | 25.0 | 24.6 |
| COMPARATIVE | −45 | −25 | 8 | 19 | 88 | 33 | 19 | 25.0 | — |
| EXAMPLE 1 | | | | | | | | | |
| COMPARATIVE | −47 | −40 | −22 | 0 | 31 | 52 | 65 | 18.0 | — |
| EXAMPLE 2 | | | | | | | | | |
| COMPARATIVE | −50 | −40 | −55 | −54 | −70 | 34 | 61 | 18.0 | — |
| EXAMPLE 3 | | | | | | | | | |
| EXAMPLE 12 | −25 | −28 | −25 | −5 | 11 | 24 | 22 | 25.0 | 24.9 |

1. A process for producing a synthetic resin film, comprising:
(A) a step of casting and applying a composition containing a polymer and an organic solvent onto a support to form a gel film;
(B) a step of stripping the gel film and heating the gel film with both ends being fixed; and
(C) a step of heating the film with both ends being released after step (B), wherein the thickness b of the film produced in step (B) and the thickness c of the film produced in step (C) satisfy the relationship b>c.

2. The process for producing the synthetic resin film according to claim 1, wherein heating in step (C) is performed under a tension of 0.10 to 1.50 kg/mm² in the machine direction (MD) of the film.

3. The process for producing the synthetic resin film according to claim 1, wherein heating in step (B) is performed at a maximum atmospheric temperature of 450° C. or lower.

4. The process for producing the synthetic resin film according to claim 1, wherein heating in step (B) is performed by treatment with hot air.

5. The process for producing the synthetic resin film according to claim 1, wherein heating in step (B) is performed by treatment with radiant heat rays.

6. The process for producing the synthetic resin film according to claim 1, wherein heating in step (B) is performed by a combination of hot air treatment and radiant heat rays treatment.

7. The process for producing the synthetic resin film according to claim 1, wherein heating in step (C) is performed at an atmospheric temperature of 430° C. or higher.

8. The process for producing the synthetic resin film according to claim 1, wherein heating in step (C) is performed by treatment with hot air.

9. The process for producing the synthetic resin film according to claim 1, wherein heating in step (C) is performed by treatment with radiant heat rays.

10. The process for producing the synthetic resin film according to claim 1, wherein heating in step (C) is performed by a combination of hot air treatment and radiant heat rays treatment.

11. The process for producing the synthetic resin film according to claim 1, wherein heating in step (C) is performed by simultaneous treatment with hot air and radiant heat rays.

12. The process for producing the synthetic resin film according to claim 1, wherein the synthetic resin film comprises a polyimide.

13. A process for producing a synthetic resin film, comprising:
(A) a step of casting and applying a composition containing a polymer and an organic solvent onto a support to form a gel film;
(B) a step of stripping the gel film and heating the gel film with both ends being fixed; and
(C) a step of heating the film with both ends being released after step (B), wherein the heating temperature in step (B) is lower than that in step (C).

14. The process for producing the synthetic resin film according to claim 13, wherein heating in step (B) is performed at a maximum atmospheric temperature of 450° C. or lower.

15. The process for producing the synthetic resin film according to claim 13, wherein heating in step (C) is performed at an atmospheric temperature of 430° C. or higher.

16. The process for producing the synthetic resin film according to claim 13, wherein the synthetic resin film comprises a polyimide.
